(19) United States
(12) Patent Application Publication
(10) Pub. No.: US 2026/0057768 A1
(43) Pub. Date: Feb. 26, 2026

(54) SYSTEMS AND METHODS FOR AUTOMATED YARD CONTROL UTILIZING AUTONOMOUS VEHICLES

(71) Applicant: Walmart Apollo, LLC, Bentonville, AR (US)

(72) Inventors: Abhijeet Prakash, Patna (IN); Raju Chautagi, Bengaluru (IN); Pavan Kumar Reddy Boppidi, Bentonville, AR (US); Najla Jannah Williams, Cypress, TX (US); Venkata Subramanian Madhu, Avalahalli (IN); Varun Guruvaram, McKinney, TX (US); Amit Kumar, Bengaluru (IN)

(21) Appl. No.: 19/299,102

(22) Filed: Aug. 13, 2025

Related U.S. Application Data
(60) Provisional application No. 63/686,228, filed on Aug. 23, 2024.

(51) Int. Cl. G08G 1/0968; G01C 21/20; G05B 13/02; G08G 1/00; G08G 1/01

(52) U.S. Cl. CPC G08G 1/0968; G01C 21/20; G05B 13/027; G08G 1/012; G08G 1/20

(57) ABSTRACT

Systems and methods for automated yard management systems are disclosed. An operation data object representative of an operation to be performed within a yard environment is received and a priority value for the operation data object is generated, at least in part, by a trained automated priority determination model. An operation assignment for the operation data object is determined based, at least in part, on the priority value. The operation assignment includes assignment to one of a manually operated vehicle or an automated vehicle. A yard path for implementation of the operation assignment within the yard environment by the one of the manually operated vehicle or the automated vehicle is determined and the operation assignment and the yard path are transmitted to the one of the manually operated vehicle or the automated vehicle.

### CROSS-REFERENCE TO RELATED APPLICATIONS

This application claims priority to Provisional Applicant No. 63/686,228, filed on Aug. 23, 2024 and entitled “Systems and Methods for Automated Yard Control Utilizing Autonomous Vehicles,” the contents of which are incorporated herein in their entirety.

### TECHNICAL FIELD

This application relates generally to autonomous vehicle movement, and more particularly, to control of autonomous vehicles within vehicle yard environment.

### BACKGROUND

Some current yard management systems provide a software solution for managing movement and storage of trailers within a vehicle yard environment, such as a distribution center. Yard management systems may be used to identify trailer movement needs indicating when a trailer within the yard environment must be moved from one location to another location. Current yard management systems utilize assignments to human drivers to perform moves within the yard environment. Reliance on human drivers can create bottlenecks or delays due to the number of moves required being greater than the number of available drivers.

### SUMMARY

In various embodiments, a system for yard management is disclosed. The system includes a non-transitory memory and a processor communicatively coupled to the non-transitory memory. The processor is configured to read a set of instructions to receive an operation data object representative of an operation to be performed within a yard environment and generate a priority value for the operation data object. The priority value is generated, at least in part, by a trained automated priority determination model. The processor is further configured to read the set of instructions to determine an operation assignment for the operation data object based, at least in part, on the priority value. The operation assignment includes assignment to one of a manually operated vehicle or an automated vehicle. The processor is further configured to read the set of instructions to determine a yard path for implementation of the operation assignment within the yard environment by the one of the manually operated vehicle or the automated vehicle and transmit the operation assignment and the yard path to the one of the manually operated vehicle or the automated vehicle.

In various embodiments, a computer-implemented method is disclosed. The method includes steps of receiving an operation data object representative of an operation to be performed within a yard environment and generating a priority value for the operation data object. The priority value is generated, at least in part, by a trained automated priority determination model. The method further includes a step of determining an operation assignment for the operation data object based, at least in part, on the priority value. The operation assignment includes assignment to one of a manually operated vehicle or an automated vehicle. The method further includes steps of determining a yard path for implementation of the operation assignment within the yard environment by the one of the manually operated vehicle or the automated vehicle and transmitting the operation assignment and the yard path to the one of the manually operated vehicle or the automated vehicle.

In various embodiments, a non-transitory computer readable medium having instructions stored thereon is disclosed. The instructions, when executed by at least one processor, cause at least one device to perform operations including receiving an operation data object representative of an operation to be performed within a yard environment and generating a priority value for the operation data object. The priority value is generated, at least in part, by a trained automated priority determination model. The instructions further cause the at least one device to perform operations including determining an operation assignment for the operation data object based, at least in part, on the priority value. The operation assignment includes assignment to one of a manually operated vehicle or an automated vehicle. The instructions further cause the at least one device to perform operations including determining a yard path for implementation of the operation assignment within the yard environment by the one of the manually operated vehicle or the automated vehicle and transmitting the operation assignment and the yard path to the one of the manually operated vehicle or the automated vehicle.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to operate one or more autonomous vehicles according to an automated yard assignment system, in accordance with some embodiments;

FIG. 2 illustrates a computer system configured to implement one or more processes, in accordance with some embodiments;

FIG. 3 is a flowchart illustrating an autonomous yard operation method, in accordance with some embodiments;

FIG. 4 is a process flow illustrating various steps of the autonomous yard operation method of FIG. 3, in accordance with some embodiments;

FIG. 5 illustrates an artificial neural network, in accordance with some embodiments;

FIG. 6 illustrates a tree-based artificial neural network, in accordance with some embodiments;

FIG. 7 illustrates a deep neural network (DNN), in accordance with some embodiments;

FIG. 8 is a flowchart illustrating a training method for generating a trained machine learning model, in accordance with some embodiments; and

FIG. 9 is a process flow illustrating various steps of the training method of FIG. 8, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for automated yard operations via automated generation, assignment, and execution of one or more moves via one or more autonomous vehicles. In various embodiments, an automated yard management system includes an assignment engine configured to generate move assignments for one or more trailers within a yard environment. The assignment engine is configured to assign moves to one of an automated vehicle or a human-operated vehicle. When assigning moves to an automated vehicle, the assignment is automatically transmitted and executed by the autonomous vehicle in response to generation of the assignment. A best-path for the move operation may be determined by the automated yard management system prior to transmitting the assignment to the autonomous vehicle or after transmitting the assignment to the autonomous vehicle and/or may be determined by the autonomous vehicle upon receipt of a transmitted assignment.

In some embodiments, systems, and methods for automated yard operations includes one or more trained automated priority determination models. The trained automated priority determination model models may include one or more models, such as trained decision tree models. The trained automated priority determination model models are configured to predict move priorities for one or more incoming events (e.g., moves) in real-time and/or to generate move assignments in real-time.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

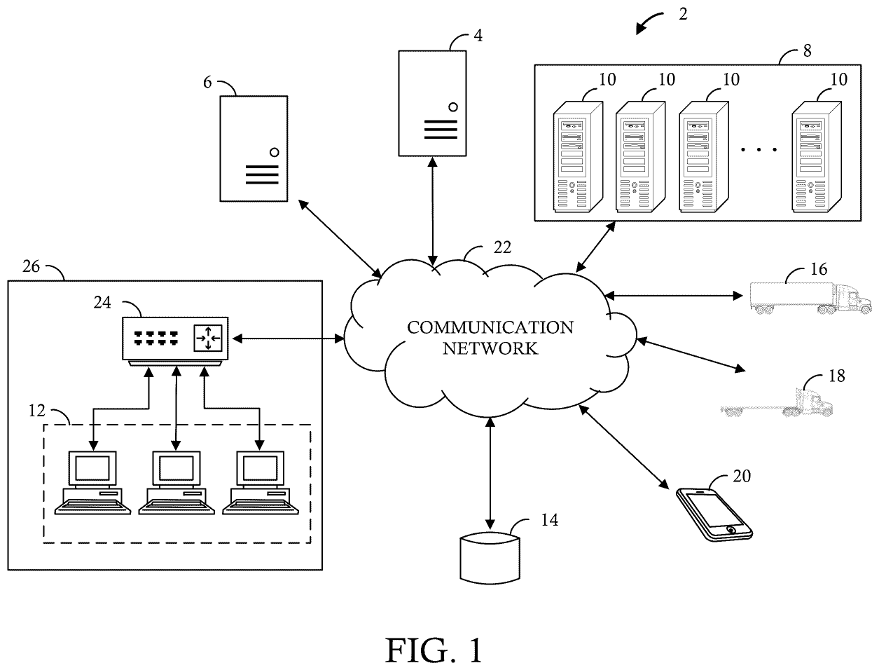

FIG. 1 illustrates a network environment 2 configured to provide operate one or more autonomous vehicles according to an automated yard assignment system, in accordance with some embodiments. The network environment 2 includes a plurality of devices or systems configured to communicate over one or more network channels, illustrated as a network cloud 22. For example, in various embodiments, the network environment 2 may include, but is not limited to, an automated yard management system computing device 4, a server 6, a cloud-based engine 8 including one or more processing devices 10, a database 14, and/or one or more vehicle computing devices 16, 18, 20 operatively coupled over the network 22. The automated yard management system computing device 4, the server 6, the processing device(s) 10, and/or the vehicle computing devices 16, 18, 20, may each be and/or include a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the automated yard management system computing device 4, the server 6, and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the automated yard management system computing device 4.

In some embodiments, each of the vehicle computing devices 16, 18, 20 may be a system integrated with a vehicle, e.g., an integrated computing system, a portion of an autonomous vehicle, etc., and/or may be stand-alone systems associated with one or more vehicles, e.g., cellular phone, a smart phone, a tablet, a personal assistant device, a voice assistant device, a digital assistant, a laptop, a computer, or any other suitable device associated with a vehicle. In some embodiments, the server 6 hosts one or more network environments, such as a yard management network environment. In some embodiments, the processing devices 10 are operated by a third party (e.g., a cloud-computing provider).

Although FIG. 1 illustrates three vehicle computing devices 16, 18, 20, the network environment 2 may include any number of vehicle computing devices 16, 18, 20. Similarly, the network environment 2 may include any number of the automated yard management system computing device 4, the server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the automated yard management system computing device 4, the server 6, the database 14, and/or the vehicle computing devices 16, 18, 20 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the vehicle computing devices 16, 18, 20 may communicate with the server 6 over the communication network 22. For example, each of the vehicle computing devices 16, 18, 20 may be operable to transmit, receive, and/or otherwise interact with a yard management network environment hosted by the server 6. In some embodiments, the vehicle computing devices 16, 18, 20 are configured to receive yard movement assignments via the server 6 and/or to send yard movement assignment acknowledgements via the server 6.

In some embodiments, the automated yard management system computing device 4 may execute one or more models, processes, or algorithms, such as a machine learning model, deep learning model, statistical model, etc., to generate move assignments for vehicle computing systems 16, 18, 20 associated with autonomous and/or manually-operated vehicles. The automated yard management system computing device 4 may transmit move assignments to the server 6 over the communication network 22, and the server 6 may provide assignments to the vehicle computing devices 16, 18, 20.

The automated yard management system computing device 4 is further operable to communicate with the database 14 over the communication network 22. For example, the automated yard management system computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the automated yard management system computing device 4, in some embodiments, the database 14 may be a local storage device, such as a hard drive, a non-volatile memory, or a USB stick. The automated yard management system computing device 4 may store interaction data received from the web server 6 in the database 14. The automated yard management system computing device 4 may also receive from the web server 6 user session data identifying events associated with browsing sessions, and may store the user session data in the database 14.

The models, when executed by the automated yard management system computing device 4, allow the automated yard management system computing device 4 to identify move requirements and/or move priorities based on received tasks or events, automatically generate and transmit move assignments for one or more user-operated and/or autonomous vehicles, cause operation of the autonomous vehicles 24, 26 to execute move assignments. For example, the automated yard management system computing device 4 may obtain one or more models from the database 14. The automated yard management system computing device 4 may then receive, in real-time via server 6, one or more real-time events, tasks, updates, etc. In response to receiving a task or event, the automated yard management system computing device 4 may execute one or more models to identify a move requirement and a corresponding priority and/or assign a move for the corresponding task or event to one of a user-operated or autonomous vehicle.

In some embodiments, the automated yard management system computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units.

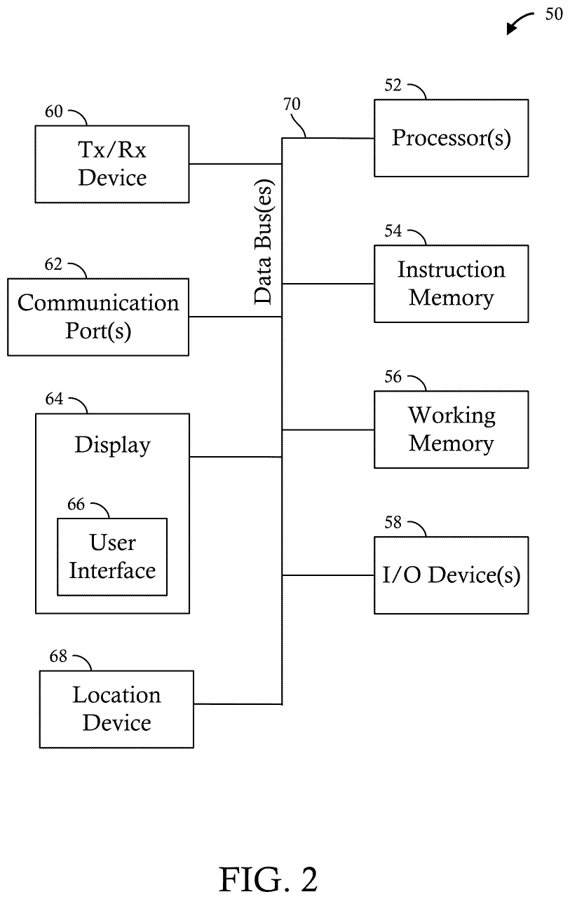

FIG. 2 illustrates a block diagram of a computing device 50, in accordance with some embodiments. In some embodiments, each of the automated yard management system computing device 4, the server 6, the one or more processing devices 10, the vehicle computing devices 16, 18, 20, and/or operational systems of the autonomous vehicles 24, 26 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for autonomous yard management and operation, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with move assignments and/or other yard management tasks. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

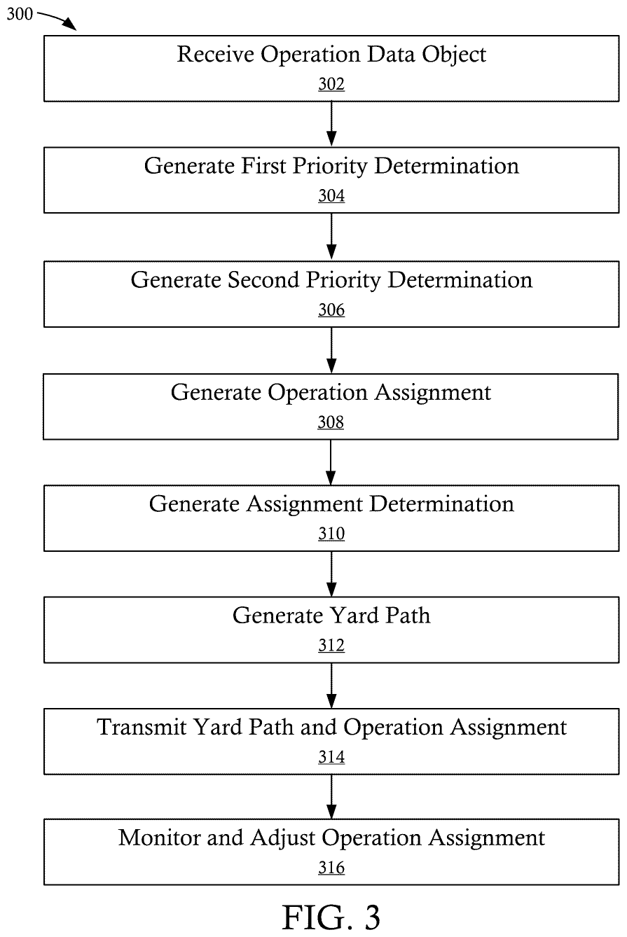

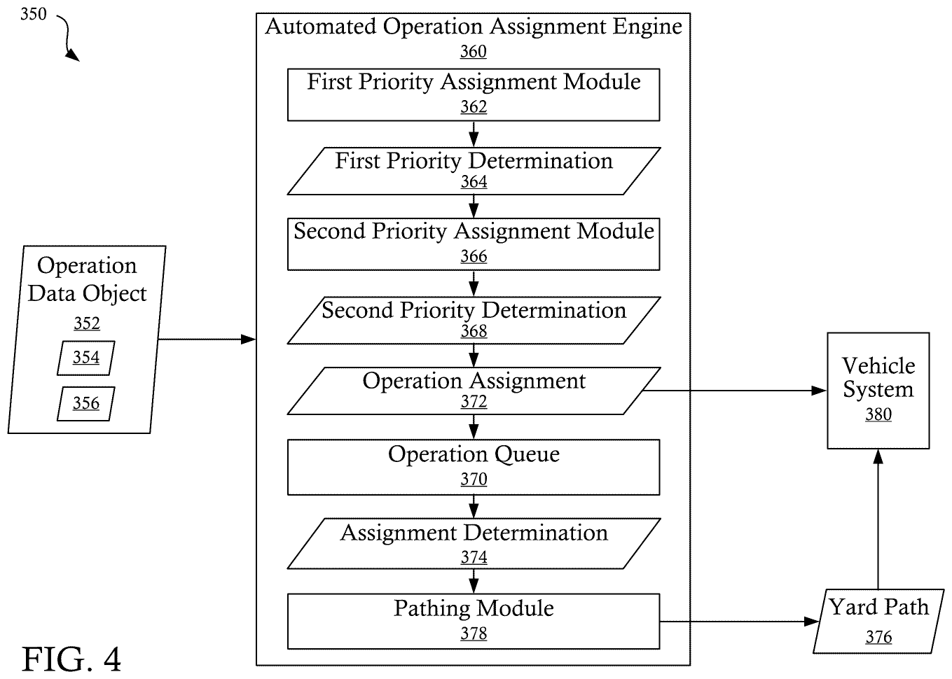

FIG. 3 is a flowchart illustrating an autonomous yard operation method 300, in accordance with some embodiments. FIG. 4 is a process flow 350 illustrating various steps and data flows of the autonomous yard operation method 300 as implemented by an automated operation assignment engine 360, in accordance with some embodiments. The autonomous yard operation method 300 may be implemented by any suitable system and/or device, such as, for example, the automated yard management system computing device 4 discussed above. Similarly, the elements of process flow 350 may include hardware and/or software components implemented on any suitable system, such as, for example, the automated yard management system computing device 4. In various embodiments, method 300 may include more or fewer blocks than are shown.

At step 302, an operation data object 352 is received. The operation data object 352 may be representative of an event, task, and/or other change that impacts positioning of one or more elements within a yard environment. For example, in some embodiments, an operation data object 352 includes a move requirement indicating movement of one or more yard elements, such as a truck, trailer, etc., to a specific and/or general position within a yard environment. As another example, in some embodiments, an operation data object 352 may include an event or task that requires execution of one or more moves within the yard environment, e.g., an incoming and/or outgoing even indicating outflow or inflow of one or more trailers. In some embodiments, the operation data object 352 is received by an automated operation assignment engine 360. The automated operations assignment engine 360 may be implemented by any suitable system, such as, for example, the automated yard management system computing device 4 of FIG. 1. In some embodiments, the operation data object 352 includes container data 354 identifying a container (e.g., trailer) within the yard environment to be moved and/or movement data 356 identifying the type and/or location of an operation corresponding to the operation data object 352. In some embodiments, container data 354, movement data 356, and/or additional operational data may be generated by the automated move assignment engine 360 in response to receiving an operation data object 352. The operation data object 352 may be received from any suitable system, such as one or more of the systems illustrated in the network environment 2, one or more third party systems, a dock manager system, a vehicle system, etc.

At step 304, a first priority determination 364 is generated. In some embodiments, the automated operation assignment engine 360 implements a first priority assignment module 362 configured to generate a first priority determination 364 for at least one yard operation, e.g., move operation, required by and/or related to a received operation data object 352. In some embodiments, the first priority determination 364 represents an initial priority value for a corresponding yard operation. The first priority assignment module 362 may be configured to apply a heuristic and/or rules-based process for generating first priority determination 364. The rules-based process may apply one or more rules for prioritizing and/or selectively assigning a yard operation.

As one non-limiting example, in some embodiments, a first priority assignment module 362 may apply a heuristic prioritization process that assigns a first priority determination 364. The first priority determination 364 may be generated on a predetermined scale, e.g., between 1 and 10, 1 and 6, etc., and/or may be determined based on scoring factors applied by the first priority assignment module 362. In some embodiments, the first priority assignment module 362 applies a rules-based process that assigns a first priority determination 364 to an outbound (e.g., shipping) move away from an entrance to the yard environment and a sub-priority based on the creation time of the move, a second priority value to an outbound move towards an entrance to the yard environment and a sub-priority based on the creation time of the move, a third priority value to bump moves and a sub-priority based on the creation time of the move, a fourth priority value to an inbound (e.g., receiving) move towards an entrance to the yard environment and a sub-priority based on the creation time of the move, a fifth priority value to an inbound (e.g., receiving) move away from an entrance to the yard environment and a sub-priority based on the creation time of the move, and a sixth priority value to any other move based on the creation time of the move. In some embodiments, the first priority assignment module 362 assigns a highest (e.g. immediate) priority value to a forced operation, as such operations may be urgent and may need to be executed as early as possible.

At step 306, a second priority determination 368 is generated. In some embodiments, the automated operation assignment engine 360 implements a second priority assignment module 366 configured to generate a second priority determination 368. In some embodiments, the second priority determination 368 represents a revised or second priority score for a yard operation associated with a received operation data object 352. Although embodiments are discussed herein including a first priority assignment module 362 and a second operation assignment module 366, it will be appreciated that the first priority assignment module 362 may be omitted and a single priority determination 368 may be generated solely by the second priority assignment module 366.

In some embodiments, the second priority assignment module 366 is configured to apply a trained machine learning model, such as an automated priority determination model, for generating second priority determination 368. The automated priority determination model may apply a trained model based on one or more model architectures to predict operation priorities for incoming operation data objects 352 in real-time. As one non-limiting example, in some embodiments, the automated priority determination model includes a decision tree framework trained using a training dataset including historical event data and/or engineered features. The decision tree framework may be adjusted to predict a target variable including a numerical priority score.

In some embodiments, the decision tree framework is adjusted to generate, e.g., predict, a priority for a yard operation related to incoming operation data object 352 based on one or more parameters. Parameters utilized by the automated priority determination model may include, but are not limited to, time sensitivity parameters, safety and compliance parameters, resource optimization parameters, operational efficiency parameters, cost and revenue parameters, real time event/emergency parameters, capacity and space management parameters, strategic goal parameters, etc. Each of the parameters may be represented by one or more data elements within the historical event data and/or the engineered features.

In some embodiments, one or more time sensitivity parameters are configured to represent a priority of a task. For example, high priority tasks/events may include movement of trailers having an urgent delivery, operations related to shipments having short-term (e.g., immediate, within a predetermined time period, etc.) deadlines, operations related to assets (e.g., trailers, vehicles, etc.) needed for immediate loading and/or unloading operations, etc. In some embodiments, one or more safety and compliance parameters are configured to represent efficient utilization of corresponding yard resources and/or one or more resource optimization parameters are configured to represent efficient utilization of yard resources. The resource optimization parameters may be configured and/or selected to prioritize operations that optimize resource utilization, minimize idle time, and/or provide smooth workflow within the yard environment. Similarly, in some embodiments, one or more operational efficiency parameters are configured to optimize overall yard operations and/or workflow efficiency, such as maximizing one or more metrics, minimizing one or more metrics, and/or increasing one or more metrics.

In some embodiments, real-time event and emergency parameters are utilized to identify operations that are prioritized in response to real-time events and/or emergencies, such as those necessitating quick responses to equipment breakdowns, accidents, and/or sudden changes in demand to minimize disruptions and/or maintain operational continuity within the yard environment. Additionally, in some embodiments, capacity and space management parameters are provided to represent prioritization of operations based on yard environment capacity and/or space availability, in order to provide optimal space allocation, prevent overutilization of resources, and/or prioritize operations that maintain efficient yard layout and storage configurations. Further, in some embodiments, one or more strategic goal parameters may be configured to align operational priorities with strategic and/or long-term yard environment objectives, such as growth of the yard environment, market factors, and/or strategic initiatives.

In some embodiments, an automated priority determination model is configured to receive a first priority determination 364 as an input parameter and output a second priority determination 368, e.g., a final priority determination, based at least in part of the first priority determination 364. For example, a first priority determination 364 may represent an initial analysis of a received operation data object 352 to identify immediate priority operations, an initial priority based on legacy priority assignments, an initial, low-cost priority estimation, etc. The first priority determination 364, as well as additional utilized parameters as discussed herein, may be provided to an automated priority determination model to generate a second priority determination 368. In some embodiments, when a first priority determination 364 has a predetermined value, such as a highest priority value, the first priority determination 364 may be utilized for additional steps described below and the second priority determination 368 may not be generated.

At step 308, an operation assignment 372 is generated for an operation corresponding to the received operation data object 352 and added to an operation queue 370. The operation assignment 372 may include a data element identifying a type of yard operation, e.g., a move operation, and a priority value. In some embodiments, the priority value is the second priority determination 368, although as discussed above, the priority value may alternatively be a first priority determination 364. The operation assignment 372 is added to the operation queue 370 based on the corresponding priority value. For example, where a priority value indicates a highest priority, e.g., a value of 0, the operation assignment 372 may be added as the next element to be processed in the operation queue 370. Operation assignments 372 having lower priority values, e.g. values between 0 and a lowest priority value (e.g., 6, 10, etc.) may be added to the operation queue 370 at a location corresponding to the priority value. In some embodiments, the operation assignment is generated by the automated operation assignment engine 360, the first priority assignment module 362, the second priority assignment module 366, and/or any other suitable module or process.

At step 310, an assignment determination 374 is generated for a next operation assignment 372 in the operation queue 370. The assignment determination 374 determines whether the corresponding operation assignment 372 is assigned to an autonomous vehicle or a manually operated vehicle. In some embodiments, the assignment determination 374 is generated by a trained machine learning model, such as an assignment determination model. The assignment determination model may include a separate model and/or may be integrated into one or more other models, such as integrated into the automated priority determination model discussed above. The assignment determination model may be implemented by any suitable process and/or system, such as, for example, as part of the automated operation assignment engine 360.

In some embodiments, the assignment determination model is configured to receive one or more factors and determine whether an operation assignment 372 may be, should be, and/or must be assigned to one of a manually operated (e.g., user operated) vehicle or an autonomous vehicle. The assignment determination model may receive one or more factors representative of an operation type. For example, in some embodiments, an operation type parameter identifies whether an operation corresponding to the operation assignment 372 is one of a normal move, a bump move, or a packet move. A normal move may include movement of a trailer within a yard environment from a first position, e.g., Point A, to a second position, e.g., Point B; a bump move may include a required alignment of a trailer at a current location; and a packet move may include movement of a trailer from an entrance or exit of a yard environment to a specific location, such as a traffic office, distribution center, etc. The assignment determination model may receive additional operation parameters, such a parameters representative of additional requirements for an operation (e.g., requirements to obtain paper documents as part of an operation, requirements for material handling, etc.), dock dedication parameters representative of whether specific vehicles and/or vehicle types are assigned to a portion of a yard environment (e.g., specific manually operated vehicle and corresponding driver assigned to first area of a yard environment), driver ranking parameters, etc.

In some embodiments, the assignment determination model is configured to receive each of the parameters related to an operation assignment 372 and generate an assignment determination 374 for one of a manually operated vehicle or an autonomous vehicle. For example, in some embodiments, when an operation type parameter indicates a bump move, a manually operated vehicle may be assigned, as certain bump moves may not be executable by an autonomous vehicle (e.g., requirement to unlock a vehicle at the location, requirement to leave a door open, etc.). Additionally, when an operation type parameter indicates a packet move, a manually operated vehicle may be assigned, as autonomous vehicles may not be capable of one or more additional requirements of a packet move (e.g., requirement to obtain paperwork from gate). When the operation type parameter indicates a normal move, additional parameters such as dock dedication parameters, may be applied to determine assignment of one of a manually operated vehicle or an autonomous vehicle. In some embodiments, the assignment determination model may default to assignment to, for example, autonomous vehicles and may provide assignments to manually operated vehicles only for specific circumstances (e.g., specific operation types, dock dedications, etc.).

The assignment determination 374 may identify a specific vehicle, e.g., a specific manually operated vehicle associated with a specific driver, a specific autonomous vehicle, etc., may identify a vehicle type corresponding to a pool of vehicles, e.g., assignment to an autonomous vehicle pool without assignment to a specific vehicle, etc. In some embodiments, the assignment determination model is configured to receive vehicle-specific parameters, such as operational status, real-time vehicle location, vehicle-assigned queues, etc., and incorporate the vehicle-specific parameters as part of an assignment determination process.

At step 312, a yard path 376 is generated for routing of an assigned vehicle to a location to perform the assigned operation and/or routing during the operation (e.g., when the operation includes a move operation). In some embodiments, the yard path 376 is generated by a pathing module 378 configured to determine a best route for the assigned vehicle from a current or expected location to a start location of the operation and/or a route for the corresponding operation. In some embodiments, the pathing module 378 is configured to apply a pathing algorithm and/or a trained pathing model configured to receive real-time yard information including current location of elements (e.g., vehicles, containers, etc.) within the yard environment, current state of a yard environment (e.g., defined travel directions, closed roads/paths, dock locations, storage area locations, known obstacles etc.), and/or any other suitable real-time yard data. The pathing module 378 may additionally and/or alternatively receive digital map data of the yard environment.

In some embodiments, the pathing module 378 is configured to determine one or more potential paths from a first location (e.g., location A) to a second location (e.g., location B) within the yard environment. The pathing module 378 may select a best-path from the one or more potential paths based on one or more selection criteria, such as, for example, path criteria related to operation of autonomous vehicles, path criteria related to operation of manually operated vehicles, path restrictions (e.g., type of vehicle, size, weight, container contents, etc.), historical movement patterns, real-time vehicle locations (e.g., congestion data), and/or any other suitable data. In some embodiments, the pathing module 378 includes a trained pathing model having a trained recurrent neural network framework configured to receive each of the foregoing parameters as inputs.

At step 314, an operation assignment 372 and corresponding yard path 376 are transmitted to an assigned vehicle system 380 for execution of the operation assignment 372 via the determined yard path 376. When the vehicle system 380 corresponds to an autonomous vehicle, transmission and receipt of the operation assignment 372 and/or corresponding yard path 376 cause the autonomous vehicle to execute the assigned operation indicated by the operation assignment 372 via the yard path 376. When the vehicle system 380 corresponds to a manually-operated vehicle, transmission and receipt of the operation assignment 372 and/or corresponding yard path 376 cause the vehicle system to notify a driver of the assigned operation and request execution of the operation by the driver via the yard path 376.

Although embodiments illustrated herein include the automated operation assignment engine 360 generating the yard path 376, it will be appreciated that, in some embodiments, the operation assignment 372 may be transmitted to an assigned vehicle without a yard path 376. The vehicle system 380 that receives the operation assignment 372 may execute the pathing process (e.g., the pathing model) discussed at step 312 after receipt of the operation assignment 372. In other embodiments, a yard path 376 may be generated only for certain vehicles and/or assignments, such as, for example, providing a yard path 376 only when the operation assignment 372 is assigned to an autonomous vehicle.

At optional step 316, execution of the operation assignment 372 is monitored and, when necessary, adjusted by the automated operation assignment engine 360. For example, when the operation assignment 372 is transmitted to a vehicle system 380 of an autonomous vehicle, the automated operation assignment engine 360 may cause execution of the operation assignment 372 by the autonomous vehicle according to the yard path 376. As another example, in some embodiments, when the operation assignment 372 is transmitted to a manually operated vehicle, the automated operation assignment engine 360 may receive a confirmation from a driver that the assignment has been received and executed. In some embodiments, the automated operation assignment engine 360 monitors the real-time location and status of the vehicle system 380 during execution the operation assignment 372. The automated operation assignment engine 360 may receive one or more operation data objects representative of one or more events encountered by the vehicle system 380 during execution of the operation assignment 372. For example, in some embodiments, an autonomous vehicle may encounter one or more obstacles, one or more unexpected pathing objects, one or more priority assignments, etc. The additional operation data object related to events encountered by the vehicle system 380 may cause the automated operation assignment engine 360 to generate one or more new operation assignments (e.g., re-assigning the operation to be executed by the first autonomous vehicle to a second vehicle, such as a second autonomous vehicle or a manually operate vehicle), generate one or more new yard paths 376, and/or otherwise modify an operation assignment 372 provided to the vehicle system 380. It will be appreciated that any suitable modification may be generated by the automated operation assignment engine 360 for a previously transmitted operation assignment 372.

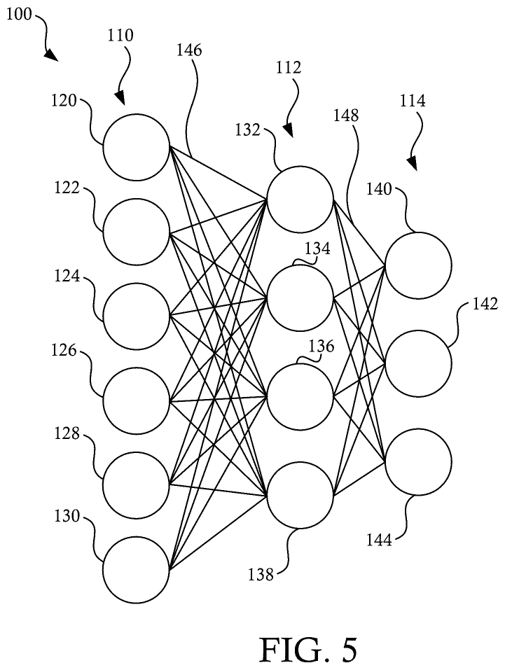

FIG. 5 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 5 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{i}^{( n )}$$

denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weight

$${w}_{i , j}^{( n , n + 1 )} .$$

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers

$${δ}_{j}^{( n )}$$

may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on

$${δ}_{j}^{( n + 1 )} ,$$

if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and

$${y}_{j}^{( n + 1 )}$$

is the comparison training value for the j-th node of the output layer 114.

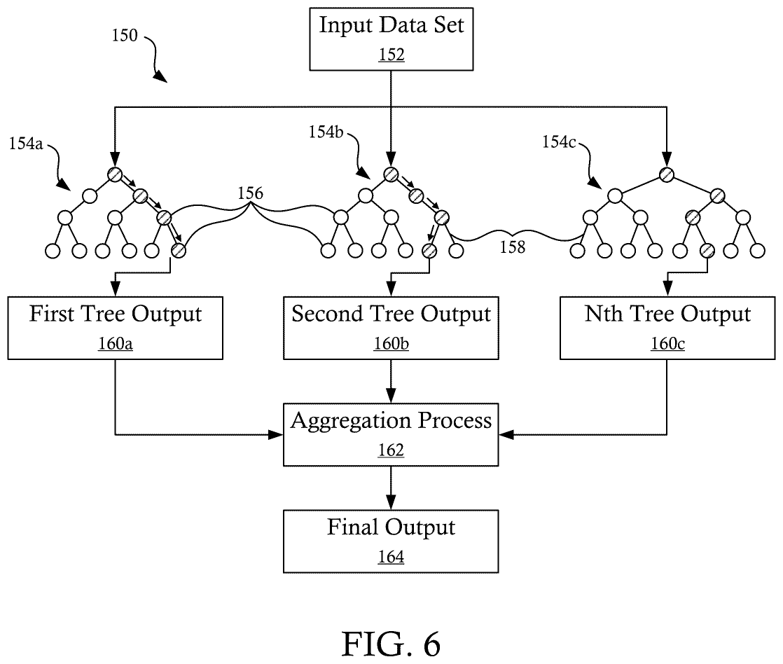

FIG. 6 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

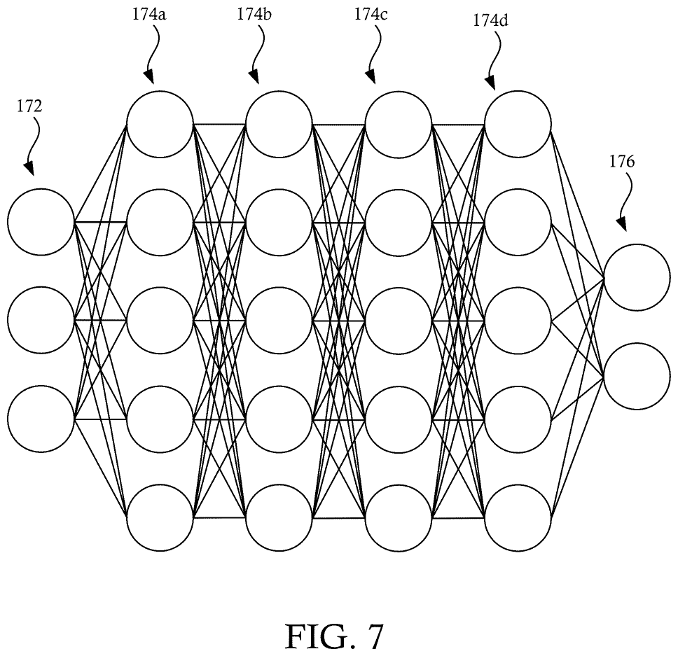

FIG. 7 illustrates a deep neural network (DNN) 170, in accordance with some embodiments. The DNN 170 is an artificial neural network, such as the neural network 100 illustrated in conjunction with FIG. 5, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

It will be appreciated that priority determinations and/or best path determinations as disclosed herein, particularly for datasets intended to be used with yard management systems, is only possible with the aid of computer-assisted machine-learning algorithms and techniques, such as automated priority determination model and/or a pathing model. In some embodiments, machine learning processes are used to perform operations that cannot practically be performed by a human, either mentally or with assistance, such as priority determinations and/or best path determinations. It will be appreciated that a variety of machine learning techniques can be used alone or in combination to generate priority determinations and/or best path determinations.

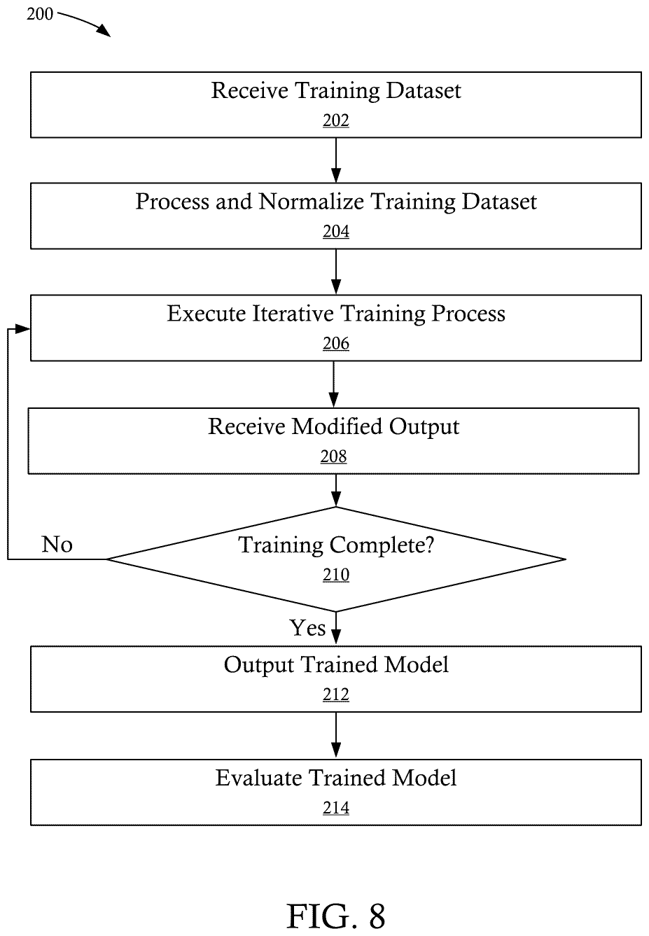

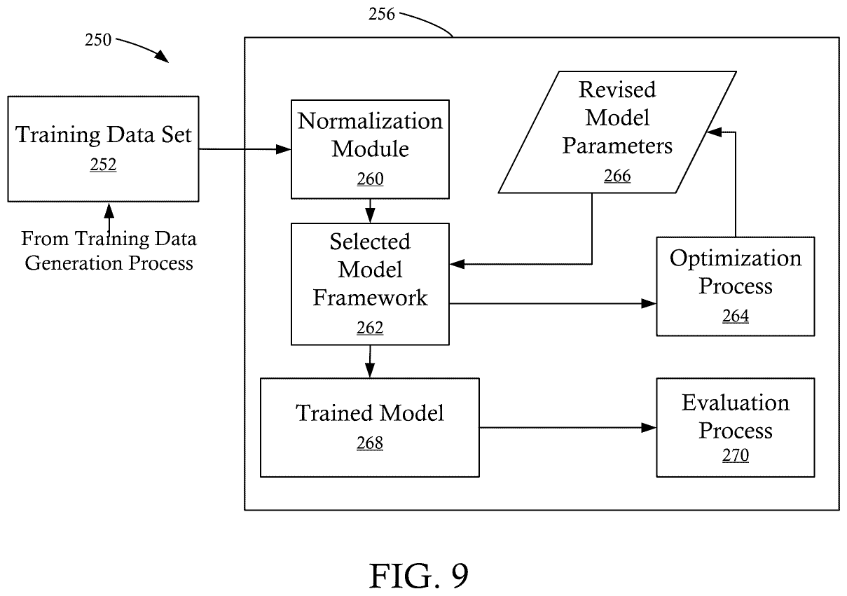

In some embodiments, automated operation assignment engine 360 may include and/or implement one or more trained models, such as an automated priority determination model and/or a pathing model. In some embodiments, one or more trained models can be generated using an iterative training process based on a training dataset. FIG. 8 illustrates a method 200 for generating a trained model, such as a trained optimization model, in accordance with some embodiments. FIG. 9 is a process flow 250 illustrating various steps of the method 200 of generating a trained model, in accordance with some embodiments. At step 202, a training dataset 252 is received by a system, such as a processing device 10. The training dataset 252 can include labeled and/or unlabeled data.

At optional step 204, the received training dataset 252 is processed and/or normalized by a normalization module 260. For example, in some embodiments, the training dataset 252 can be augmented by imputing or estimating missing values of one or more features associated with priority determinations and/or pathing determinations. In some embodiments, processing of the received training dataset 252 includes outlier detection configured to remove data likely to skew training of a corresponding model framework, such as a decision tree framework and/or a recurrent neural network framework. In some embodiments, processing of the received training dataset 252 includes removing features that have limited value with respect to training of the corresponding model.

At step 206, an iterative training process is executed to train a selected model framework 262. The selected model framework 262 can include an untrained (e.g., base) machine learning framework and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. In some embodiments, the cost value is related to priority determinations and/or path selection.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained model 268 is output and provided for use by the automated operation assignment engine 360. At optional step 212, a trained model 268 can be evaluated by an evaluation process 270. A trained model can be evaluated based on any suitable metrics, such as, for example, an For F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a processor; and
a non-transitory memory storing instructions that, when executed, cause the processor to:
receive an operation data object representative of an operation to be performed within a yard environment;
generate a priority value for the operation data object, wherein the priority value is generated, at least in part, by a trained automated priority determination model;
determine an operation assignment for the operation data object based, at least in part, on the priority value, wherein the operation assignment includes assignment to one of a manually operated vehicle or an automated vehicle;
determine a yard path for implementation of the operation assignment within the yard environment by the one of the manually operated vehicle or the automated vehicle; and
transmit the operation assignment and the yard path to the one of the manually operated vehicle or the automated vehicle.

2. The system of claim 1 wherein the instructions, when executed, cause the processor to generate an initial priority value based on an application of a heuristic prioritization process to the operation data object, wherein the priority value is generated, at least in part, by the trained automated priority determination model based on the initial priority value.

3. The system of claim 1, wherein the instructions, when executed, cause the processor to generate an initial priority value based on an application of a rules-based process to the operation data object, wherein the priority value is generated, at least in part, by the trained automated priority determination model based on the initial priority.

4. The system of claim 3, wherein the generation of the initial priority value comprises a determination of an operation type of the operation data object and, based on the determination, a generation of a first initial priority value for a first type of the operation data object, a generation of a second initial priority value for a second type of the operation data object, and a generation of a third initial priority value for a third type of the operation data object.

5. The system of claim 4, wherein the generation of the initial priority value comprises a generation of a sub-priority based on a creation time of the operation data object.

6. The system of claim 1 wherein the instructions, when executed, cause the processor to use a trained machine learning model to generate the operation assignment based on the priority value and an operation type of the operation data object.

7. The system of claim 1 wherein the instructions, when executed, cause the processor to receive real-time yard information of the yard environment, the real-time yard information comprising a current location of elements, and determine the yard path based on the real-time yard information.

8. The system of claim 1 wherein, to determine the yard path, the instructions, when executed, cause the processor to determine a best route for the manually operated vehicle or the automated vehicle from a current or expected location to a start location of the operation.

9. The system of claim 8 wherein, to determine the best route, the instructions, when executed, cause the processor to determine the best route from a plurality of routes based on path criteria, wherein the path criteria comprises path criteria related to operation of autonomous vehicles, path criteria related to operation of manually operated vehicles, path restrictions, historical movement patterns, and real-time vehicle locations.

10. The system of claim 9 wherein, to determine the best route, the instructions, when executed, cause the processor to input the path criteria to a trained pathing model having a trained recurrent neural network framework.

11. The system of claim 1, wherein, when the transmission of the operation assignment and the yard path is to the automated vehicle, receipt of the transmission causes the automated vehicle to execute the assigned operation indicated by the operation assignment using the yard path.

12. The system of claim 1, wherein, when the transmission of the operation assignment and the yard path is to the manually operated vehicle, receipt of the transmission causes the manually operated vehicle to notify a driver of the operation assignment and to request execution of the operation by the driver using the yard path.

13. The system of claim 12, wherein the instructions, when executed, cause the processor to receive a confirmation from the driver of the manually operated vehicle that the assignment has been received and executed.

14. A computer-implemented method, comprising:
receiving an operation data object representative of an operation to be performed within a yard environment;
generating a priority value for the operation data object, wherein the priority value is generated, at least in part, by a trained automated priority determination model;
determining an operation assignment for the operation data object based, at least in part, on the priority value, wherein the operation assignment includes assignment to one of a manually operated vehicle or an automated vehicle;
determining a yard path for implementation of the operation assignment within the yard environment by the one of the manually operated vehicle or the automated vehicle; and
transmitting the operation assignment and the yard path to the one of the manually operated vehicle or the automated vehicle.

15. The computer-implemented method of claim 14, comprising generating an initial priority value based on an application of a heuristic prioritization process to the operation data object, wherein the priority value is generated, at least in part, by the trained automated priority determination model based on the initial priority value.

16. The computer-implemented method of claim 14, comprising generating an initial priority value based on an application of a rules-based process to the operation data object, wherein the priority value is generated, at least in part, by the trained automated priority determination model based on the initial priority value.

17. The computer-implemented method of claim 16, wherein generating the initial priority value comprises a determination of an operation type of the operation data object and, based on the determination, a generation of a first initial priority value for a first type of the operation data object, a generation of a second initial priority value for a second type of the operation data object, and a generation of a third initial priority value for a third type of the operation data object.

18. The computer-implemented method of claim 14, comprising receiving real-time yard information of the yard environment, the real-time yard information comprising a current location of elements, and determining the yard path based on the real-time yard information.

19. A non-transitory computer readable medium having instructions stored thereon, wherein the instructions, when executed by at least one processor, cause the at least one processor to:
receive an operation data object representative of an operation to be performed within a yard environment;
generate a priority value for the operation data object, wherein the priority value is generated, at least in part, by a trained automated priority determination model;
determine an operation assignment for the operation data object based, at least in part, on the priority value, wherein the operation assignment includes assignment to one of a manually operated vehicle or an automated vehicle;
determine a yard path for implementation of the operation assignment within the yard environment by the one of the manually operated vehicle or the automated vehicle; and
transmit the operation assignment and the yard path to the one of the manually operated vehicle or the automated vehicle.

20. The non-transitory computer readable medium of claim 19 wherein the instructions, when executed, cause the at least one processor to generate an initial priority value based on an application of a heuristic prioritization process to the operation data object, wherein the priority value is generated, at least in part, by the trained automated priority determination model based on the initial priority value.
